(19) United States
(12) Patent Application Publication
(10) Pub. No.: US 2005/0180077 A1
(43) Pub. Date: Aug. 18, 2005

(54) Power supply circuit

(75) Inventor: Hiroshi Hattori, Chita-gun (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/048,866

(22) Filed: Feb. 3, 2005

(30) Foreign Application Priority Data
Feb. 17, 2004 (JP) 2004-40203

(51) Int. Cl. H02H 9/00

(52) U.S. Cl. 361/103

(57) ABSTRACT

A power supply circuit for a load has a first differential amplifier circuit, a first voltage-current conversion circuit, a second voltage-current conversion circuit, a reference voltage circuit, a second differential amplifier circuit, and an overheat protection circuit. The power supply circuit is constructed as an integrated circuit. A current detector circuit and bipolar transistors are attached externally to the integrated circuit. The power supply circuit can increase its output current with the reliability ensured, thus becoming able to supply a wide range of output currents.

### CROSS REFERENCE TO RELATED APPLICATION

This application is based on and incorporates herein by reference Japanese Patent Application No. 2004-40203 filed on Feb. 17, 2004.

### FIELD OF THE INVENTION

This invention relates to a power supply circuit of a series regulator system.

### BACKGROUND OF THE INVENTION

Conventionally, as a power supply circuit which can maintain its output voltage constant against variation of a load, a series regulator system is disclosed in JP-A-2001-337729. This series regulator is comprised of a booster transistor, a driver transistor for driving the booster transistor, and a differential amplifier. The differential amplifier compares an output voltage of the series regulator with a reference voltage and controls the booster transistor according to a difference between the two voltages through the driver transistor. The power supply circuit can thus ensure a constant output voltage.

From the point of view of circuit design, when an output current flowing through this booster transistor is small, it is possible to integrate the booster transistor, the driving transistor and the differential amplifier in an IC (integrated circuit) monolithically. However, in the case where the output current is large, generation of heat within the booster transistor becomes large. Hence it is not possible to integrate the booster transistor in the IC monolithically.

Therefore, it becomes necessary that the driver transistor and the differential amplifier are integrated in an IC monolithically, and an external booster transistor is attached to this IC as a discrete device.

In recent years, an air bag system has developed into various kinds ranging from a small one that has only front seat air bags (for driver's seat and passenger's seat) to a large one that has rear seat air bags, side air bags, knee air bags, etc. additionally. With such diversification of the air bag systems, it has become necessary for power supply circuits of ECU (electronic control unit) forming the air bag systems to deliver large output currents as well as those of small output currents. When the above series regulator is used as a power supply circuit of ECU for an air bag system, two configurations are proposed.

In one configuration, a plurality of ICs are provided according to output current magnitudes. In the other configuration, a single IC capable of delivering a large output current needed is used to meet output currents of any magnitudes needed.

However, if a plurality of ICs each corresponding to an output current of a given magnitude are to be provided, a considerable amount of costs is required for development of these ICs. On the other hand, if a single IC capable of delivering output currents of any magnitudes needed is used for output currents of any magnitudes, the IC becomes relatively expensive in power supply circuits of small magnitudes as compared to an IC optimized for the current of that magnitude. Furthermore, this circuit configuration fails to realize a sophisticated protection capability which conforms to an output current magnitude.

### SUMMARY OF THE INVENTION

It is an object of this invention to provide an improved power supply circuit which is less expensive and supports a wide range of output currents while ensuring reliability.

A power supply circuit according to the present invention comprises, a first differential amplifier circuit, a first voltage-current conversion circuit, a second voltage-current conversion circuit, a reference voltage circuit and a second differential amplifier circuit. Those circuits are constructed monolithically as an integrated circuit. This integrated circuit is connectable to an external current supply path to increase a current to drive a load.

The first differential amplifier circuit compares a first voltage corresponding to an output voltage applied to the load with a first reference voltage and generates a first difference voltage. The first voltage-current conversion circuit converts the first difference voltage to a first current and supplies the first current to the load. The second voltage-current conversion circuit converts the first difference voltage to a second current. The reference voltage circuit generates a second reference voltage from the second current. The second differential amplifier circuit compares a second voltage proportional to a magnitude of an external current supplied to the load through the external current path different from a current path of the first current with the second reference voltage, and generates a second difference voltage.

### BRIEF DESCRIPTION OF THE DRAWINGS

The above and other objects, features and advantages of the present invention will become more apparent from the following detailed description made with reference to the accompanying drawings. In the drawings:

FIG. 1 is a circuit diagram of a power supply circuit in a first embodiment of the present invention;

FIG. 2 is a circuit diagram of a power supply circuit in a second embodiment of the present invention; and

FIG. 3 is a circuit diagram of a power supply circuit in a third embodiment of the present invention.

### DETAILED DESCRIPTION OF THE PREFERRED EMBODIMENTS

In the following embodiments, a power supply circuit is placed in, for example, an ECU for an air bag and used as a power supply circuit which generates an output voltage of 5 V used to drive a circuit from 12 V output voltage of a vehicle storage battery.

### First Embodiment

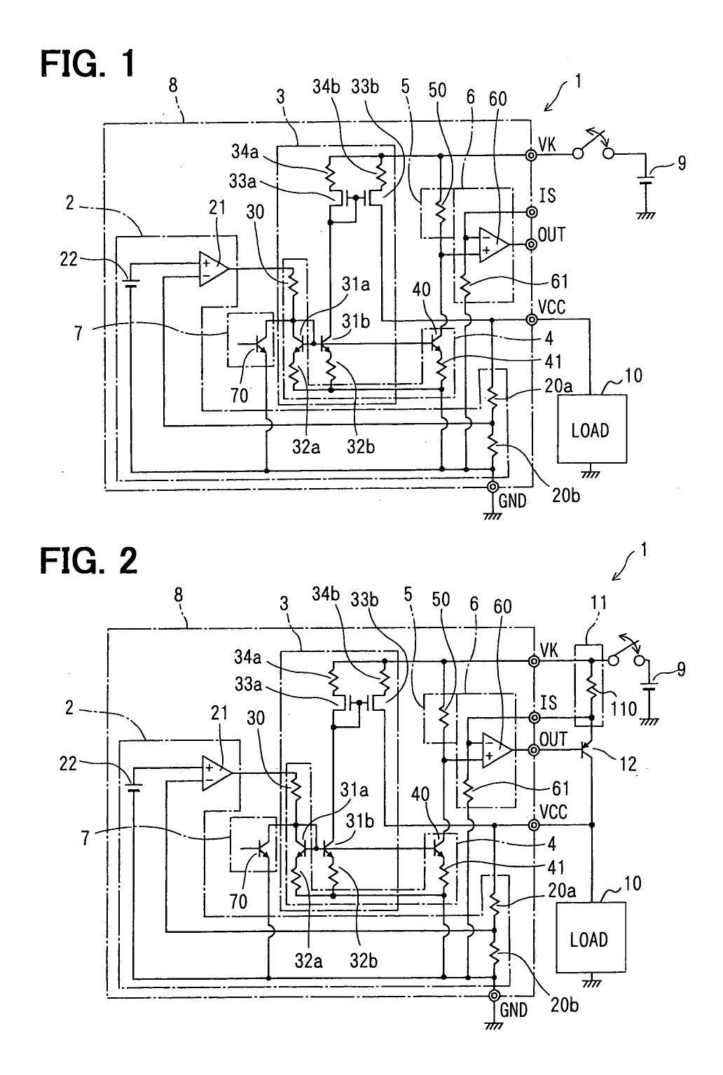

Referring to FIG. 1, a power supply circuit 1 is made up of an IC 8 which is comprised of a first differential amplifier circuit 2, a first voltage-current conversion circuit 3, a second voltage-current conversion circuit 4, a reference voltage circuit 5, a second differential amplifier circuit 6, and an overheat protection circuit 7.

The first differential amplifier circuit 2 is comprised of resistors 20a and 20b, a differential amplifier 21, and a reference supply 22. The resistor 20a and the resistor 20b are connected in series. One end of this serially connected resistors 20a and 20b is connected to a load 10 via an output terminal VCC of the IC 8, and the other end of the same is connected to a vehicle chassis via a terminal GND of the IC 8.

An inverting input terminal of the differential amplifier 21 is connected to the junction between the resistor 20a and the resistor 20b, and a non-inverting input terminal of the same is connected to a positive electrode terminal of the reference supply 22. A negative electrode terminal of the reference supply 22 is grounded to the vehicle chassis via the terminal GND. An output terminal of the differential amplifier 21 is connected to the first voltage-current conversion circuit 3.

The first voltage-current conversion circuit 3 is constructed with two current mirror circuits.

A first current mirror circuit is comprised of bipolar transistors 31a, 31b, and 40 and resistors 32a, 32b, and 41. The bases of the bipolar transistors 31a, 31b, and 40 are all connected to the collector of the bipolar transistor 31a, the emitters of the same are connected to one ends of the resistors 32a, 32b, and 41, respectively. The other ends of the resistor 32a, 32b, and 41 are grounded to the vehicle chassis all via the terminal GND. Resistance values of the resistors 32a, 32b, and 41 are set such that the ratio of collector currents of the bipolar transistors 31a, 31b, and 40 becomes a given ratio, for example, 1:10:10.

A second current mirror circuit is comprised of field effect transistors 33a, 33b and resistors 34a, 34b. The gates of the field effect transistors 33a and 33b are both connected to the drain of the field effect transistor 33a, and the sources of the same are connected to one ends of the resistors 34a and 34b, respectively. The other ends of the resistors 34a and 34b are both connected to the positive electrode terminal of the battery 9 via an input terminal VK. The mirror ratio (size ratio) of the field effect transistors 33a and 33b is set such that the ratio of their drain currents assumes a given value, for example, 1:50.

The first voltage-current conversion circuit 3 is comprised of resistors 30, 32a, 32b, 34a, and 34b, the bipolar transistors 31a and 31b, and the field effect transistors 33a and 33b. One end of the resistor 30 is connected to the output terminal of the differential amplifier 21, and the other end of the same is connected to the collector of the bipolar transistor 31a, respectively. The collector of the bipolar transistor 31b is connected to the drain of the field effect transistor 33a. The drain of the field effect transistor 33b is connected to the load 10 via the output terminal VCC.

The second voltage-current conversion circuit 4 has the first current mirror circuit described above internally, and is comprised of resistors 30, 32a, and 41 and the bipolar transistors 31a and 40. The collector of the bipolar transistor 40 is connected to the reference voltage circuit 5.

The reference voltage circuit 5 is made up of a resistor 50. One end of the resistor 50 is connected to the collector of the bipolar transistor 40, and the other end of the same is connected to the battery 9 via the input terminal VK, respectively.

The second differential amplifier circuit 6 is comprised of a differential amplifier 60 and a resistor 61. A non-inverting input terminal of the differential amplifier 60 is connected to a junction between the collector of the bipolar transistor 40 and the resistor 50, and an inverting input terminal of the same is connected to a terminal IS to which a current detector circuit needed when increasing the output current is connected and one end of the resistor 61, respectively. The other end of the resistor 61 is grounded to the vehicle chassis via the terminal GND. The output terminal of the differential amplifier 60 is connected to a terminal OUT to which a transistor needed when increasing the output current is connected.

The overheat protection circuit 7 is made up of a bipolar transistor 70. The collector of the bipolar transistor 70 is connected to the collector of the bipolar transistor 31a, and the emitter of the same is grounded to the vehicle chassis via the terminal GND. Moreover, the base of the bipolar transistor 70 is connected to an overheat detector circuit (not shown) which is installed in the IC 8 and detects overheat inside the IC 8.

In the first embodiment, when the output voltage of the battery 9 is fed to the input terminal VK of the IC 8, the power supply circuit 1 will start its operation. The output voltage of the power supply circuit 1 is outputted from the output terminal VCC of the IC 8 to drive the load 10. This output voltage is divided into voltages by the resistor 20a and the resistor 20b.

One of the divided voltages is applied to the inverting input terminal of the differential amplifier 21, which compares the divided voltage with a voltage (a first reference voltage) of the reference supply 22 which is connected to the non-inverting input terminal. The differential amplifier 21 applies a voltage which is in proportion to the difference between the two voltages to the resistor 30 of the first voltage-current conversion circuit 3.

As a result, a collector current which is in proportion to the difference between the output voltage of the power supply circuit 1 and the voltage of the reference supply flows in the bipolar transistor 31a through the resistor 30. This collector current of the bipolar transistor 31a is made to pass through the bipolar transistor 31b which, together with the bipolar transistor 31a, forms the first current mirror circuit and enter the second current mirror circuit.

The field effect transistor 33b forming the second current mirror circuit maintains its output voltage constant, and supplies a drain current (a first output current), which is 500 times larger than the collector current of the bipolar transistor 31a, to the load via the output terminal VCC. For example, when the differential amplifier circuit 2 and the resistor 30 of the first voltage-current conversion circuit 3 are set such that a current of up to 200 pA flows in the bipolar transistor 31a, the field effect transistor 33b can supply an output current of up to 100 mA to the load 10 via the output terminal VCC. Moreover, a collector current, which is 10 times larger than the collector current of the bipolar transistor 31a, flows in the bipolar transistor 40 forming the first current mirror circuit.

This collector current of the bipolar transistor 40 is converted to a voltage (a second reference voltage) by the resistor 50 forming the reference voltage circuit 5. This voltage is fed to the non-inverting input terminal of the differential amplifier 60. However, no circuit is connected to the output terminal of the differential amplifier 60 at all. Consequently the differential amplifier circuit 60 does not affect the output of the power supply circuit 1.

When the inside of the IC 8 is overheated to, for example, 150° C. or more, the overheat detector circuit detects this overheating and applies a voltage to the base of the bipolar transistor 70 of the overheat protection circuit 7. Then, a base current flows in the bipolar transistor 70, and turns on the bipolar transistor 70. The turn-on of the bipolar transistor 70 cuts off the collector currents of the bipolar transistors 31a and 40. Further, the cut-off of the collector current of the bipolar transistor 31a cuts off the drain current of the field effect transistor 33b as well. Consequently, the power supply circuit 1 suspends its output.

According to the first embodiment, the power supply circuit 1 can ensure its output voltage by the field effect transistor 33b forming the first voltage-current conversion circuit 3, and can supply a small output current, for example, 100 mA to the load 10. In addition, since the power supply circuit 1 can be constructed in the form of the IC 8, the cost can be reduced.

It should be noted that the power supply circuit 1 is constructed with the first voltage-current conversion circuit 3 including the current mirror circuit. Therefore, the power supply circuit 1 cannot supply a current which exceeds a maximum output current, for example, 100 mA determined by circuit parameters to the load 10. Thus, when the power supply circuit 1 becomes overloaded, the output voltage of the power supply circuit 1 drops, and the overload can be detected by a supply voltage drop detector circuit or the like installed in the load 10 connected thereto, i.e., the ECU.

When the inside of the IC 8 becomes overheated to, for example, 150° C. or more, the output of the power supply circuit 1 can be suspended by the overheat protection circuit 7. Consequently, the power supply circuit can be constructed as a very reliable device. Moreover, the power supply circuit 1 can perform voltage-current conversion certainly by constructing the first voltage-current conversion circuit 3 and the second voltage-current conversion circuit 4 each in the form of a current mirror circuit.

### Second Embodiment

In the second embodiment, the same components as those of the first embodiment are designated by similar references to give the explanation.

As shown in FIG. 2, the power supply circuit 1 is constructed by attaching a current detector circuit 11 and a bipolar transistor 12 (main transistor) externally to the IC 8 including the first differential amplifier circuit 2, the first voltage-current conversion circuit 3, the second voltage-current conversion circuit 4, the reference voltage circuit 5, the second differential amplifier circuit 6, and the overheat protection circuit 7.

The current detector circuit 11 is made up of a resistor 110. One end of the resistor 110 is connected to the battery 9, and the other end of the same is connected to both the terminal IS of the IC 8 and the emitter of the bipolar transistor 12, respectively. The base of the bipolar transistor 12 is connected to the terminal OUT of the IC 8, and the collector of the same is connected to the load 10 via the output terminal VCC, respectively.

In the second embodiment, a collector current, which is 10 times larger than the collector current of the bipolar transistor 31a flows in the bipolar transistor 40 forming the first current mirror circuit. This collector current of the bipolar transistor 40 is converted to a voltage (the second reference voltage) by the resistor 50 forming the reference voltage circuit 5, and fed to the non-inverting input terminal of the differential amplifier 60. A collector current (second output current) of the bipolar transistor 12 flows in the resistor 110 forming the current detector circuit 11. This collector current of the bipolar transistor 12 is converted to a voltage by the resistor 110 and fed to an inverting input terminal of the differential amplifier 60.

The differential amplifier 60 controls the bipolar transistor 12 by applying a voltage to the base of the bipolar transistor 12 so that a voltage which the current detector circuit 11 generates becomes equal to a voltage which the reference voltage circuit 5 generates. By this operation, the bipolar transistor 12 maintains its output voltage constant, and supplies a collector current to the load 10 so that the voltage which the current detector circuit 11 generates becomes equal to the voltage which the reference voltage circuit 5 generates.

For example, when the differential amplifier circuit 2 and the resistor 30 of the first voltage-current conversion circuit 3 are set such that a current of up to 200 μA flows in the bipolar transistor 31a, the bipolar transistor 40 can supply a current of up to 2 mA to the reference supply circuit 5.

At this time, for example, when the resistor 50 of the reference supply circuit 5 is 200 Ω and the resistor 110 of the current detector circuit 11 is 2 Ω, since the voltage which the reference supply circuit 5 generates is 0.4 V at the maximum, the bipolar transistor 12 can supply its output current of up to 200 mA to the load 10. As a result, the power supply circuit 1 can supply an output current of up to 300 mA, which is a sum of the drain current of the field effect transistor 33b and the collector current of the bipolar transistor 12, to the load 10.

According to the second embodiment, the power supply circuit 1 can ensure the output voltage by attaching the resistor 110 forming the current detector circuit 11 and the bipolar transistor 12 externally to the IC 8, and can increase its output current of up to 300 mA as described above.

In case a disconnection occurs in a path from the terminal IS of the IC 8 to both the resistor 110 and the emitter of the bipolar transistor 12, or in a path from the terminal OUT to the base of the bipolar transistor 12, the bipolar transistor 12 turns off and the power supply circuit 1 becomes overloaded. Then, the output voltage of the power supply circuit 1 drops, and overload can be detected on the load 10 side. Therefore, the power supply circuit can be made very reliable.

### Third Embodiment

In the third embodiment, the same components as those of the above embodiments are designated by similar references.

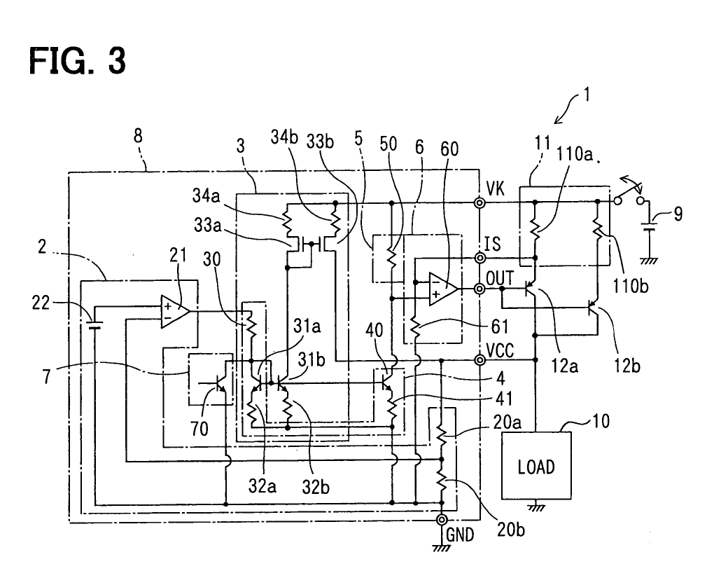

As shown in FIG. 3, the power supply circuit 1 is constructed by attaching the current detector circuit 11 and bipolar transistors 12a and 12b (main transistors) externally to the IC 8 including the first differential amplifier circuit 2, the first voltage-current conversion circuit 3, the second voltage-current conversion circuit 4, the reference voltage circuit 5, the second differential amplifier circuit 6, and the overheat protection circuit 7.

The current detector circuit 11 is made up of resistors 110a and 110b. One end of the resistor 110a is connected to the battery 9, and the other end of the same is connected to both the terminal IS of the IC 8 and the emitter of the bipolar transistor 12a, respectively. The base of the bipolar transistor 12a is connected to the terminal OUT of the IC 8, and the collector of the same is connected to the load 10 via the output terminal VCC, respectively.

One end of the resistor 110b is connected to the battery 9, and the other end of the same is connected to the emitter of the bipolar transistor 12b, respectively. The base of the bipolar transistor 12b is connected to the terminal OUT of the IC 8, and the collector of the same is connected to the load 10 via the output terminal VCC, respectively.

The differential amplifier 60 controls the bipolar transistors 12a and 12b by applying a voltage to the bases of the bipolar transistors 12a and 12b so that the voltage which the current detector circuit 11 generates becomes equal to the voltage which the reference voltage circuit 5 generates. By this operation, the bipolar transistors 12a and 12b maintain their output voltages constant, and supply the collector currents to the load 10, respectively, so that the voltage which the current detector circuit 11 generates and the voltage which the reference voltage circuit 5 generates become equal.

For example, when the differential amplifier circuit 2 and the resistor 30 of the first voltage-current conversion circuit 3 are set in such a way that a current of up to 200 μA flows in the bipolar transistor 31a, the bipolar transistor 40 is enabled to feed a current of up to 2 mA to the reference supply circuit 5.

At this time, when the resistor 50 of the reference supply circuit 5 is 200 Ω and the resistors 110a and 110b of the current detector circuit 11 are both 1 Ω, since the voltage which the reference supply circuit 5 generates is 0.4 V at the maximum, and then each of the bipolar transistors 12a and 12b can supply an output current of up to 400 mA to the load 10, respectively. As a result, the power supply circuit 1 can supply its output current of up to 900 mA, which is a sum of the drain current of the field effect transistor 33b and the collector currents of the bipolar transistors 12a and 12b, to the load 10.

According to the third embodiment, by attaching the resistors 110a and 110b forming the current detector circuit 11 and the bipolar transistors 12a and 12b externally to the IC 8, the power supply circuit 1 can ensure the output voltage and can further increase its output current of up to, for example, 900 mA.

In the third embodiment, more than two pairs of a transistor and a resistor which are connected in series may be connected in parallel between the VCC terminal and the terminal VK of the IC 8 to form the current detector circuit.

The present invention should not be limited to the disclosed embodiments, but may be modified in other ways without departing from the spirit of the invention.

1. A power supply circuit for a load comprising:
a first differential amplifier circuit which compares a first voltage corresponding to an output voltage applied to the load with a first reference voltage and generates a first difference voltage corresponding to a first difference between the first voltage and the first reference voltage;
a first voltage-current conversion circuit which converts the first difference voltage to a first current and supplies the first current to the load;
a second voltage-current conversion circuit which converts the first difference voltage to a second current;
a reference voltage circuit which generates a second reference voltage from the second current; and
a second differential amplifier circuit which compares a second voltage proportional to a magnitude of an external current supplied to the load through another current path different from a current path of the first current with the second reference voltage, and generates a second difference voltage corresponding to a second difference between the second voltage and the second reference voltage,
wherein the first differential amplifier circuit, the first voltage-current conversion circuit, the second voltage-current conversion circuit, the reference voltage circuit, and the second differential amplifier circuit are constructed monolithically as an integrated circuit.

2. The power supply circuit according to claim 1, further comprising:
a transistor attached externally to the integrated circuit and connected in the another current path to supply the external current to the load; and
a current detector circuit which is attached externally to the integrated circuit and generates the second voltage proportional to the magnitude of the external current.

3. The power supply circuit according to claim 1, further comprising:
an overheat protection circuit which is constructed in the integrated circuit and sets the first current and the second current to approximately zeros, respectively, when a temperature of the integrated circuit reaches a predetermined temperature.

4. The power supply circuit according to claim 1, wherein each of the first voltage-current conversion circuit and the second voltage-current conversion circuit is comprised of a current mirror circuit.

5. A power supply circuit for a load comprising:
an integrated circuit, connected to the load, for supplying a primary current to the load, the integrated circuit including a first detection circuit for detecting a voltage to the load to regulate the primary current to a predetermined level;
a switching device, connected externally to the integrated circuit, for supplying a secondary current to the load in addition to the primary current;
a second detection circuit, connected to the switching device in series and externally to the integrated circuit, for detecting the secondary current,
wherein the integrated circuit further includes a control circuit means, which is connected to the second detection circuit for controlling the secondary current in accordance with a function of the voltage detected by the first detection circuit.

6. The power supply circuit according to claim 5, wherein the control circuit means includes a differential amplifier which compares a voltage corresponding to the secondary current with a voltage corresponding to the voltage detected by the first detection circuit, and controls the switching device.
